(19) United States
(12) Patent Application Publication
(10) Pub. No.: US 2014/0285026 A1
(43) Pub. Date: Sep. 25, 2014

(54) WIRELESS POWER SUPPLY SYSTEM, POWER RECEPTION CONTROLLING APPARATUS AND POWER TRANSMISSION CONTROLLING APPARATUS

(71) Applicant: KABUSHIKI KAISHA TOSHIBA, Minato-ku (JP)

(72) Inventor: Eiji Hori, Yokohama-Shi (JP)

(73) Assignee: KABUSHIKI KAISHA TOSHIBA, Minato-ku (JP)

(21) Appl. No.: 14/016,696

(22) Filed: Sep. 3, 2013

(30) Foreign Application Priority Data
Mar. 22, 2013 (JP) 2013-060315

(51) Int. Cl. H01F 38/14

(52) U.S. Cl. CPC H01F 38/14
USPC 307/104

(57) ABSTRACT

The wireless power supply system includes a power transmitting unit that transmits electric power. The wireless power supply system includes a power receiving unit that receives the electric power output from the power transmitting unit. The wireless power supply system according to the first embodiment can detect a foreign matter based on the power transmission frequency.

### CROSS-REFERENCE TO RELATED APPLICATION

This application is based upon and claims the benefit of priority from the prior Japanese Patent Application No. 2013-060315, filed on Mar. 22, 2013, the entire contents of which are incorporated herein by reference.

### BACKGROUND

1. Field

Embodiments described herein relate generally to a wireless power supply system.

2. Background Art

There is a wireless power supply system that detects adhesion of a foreign matter based on a result of measurement with a thermal sensor, a result of measurement of the impedance on a transmitting side or a result of measurement of the efficiency of the whole of the system.

### BRIEF DESCRIPTION OF THE DRAWINGS

FIG. 1 is a diagram showing an example of a configuration of a wireless power supply system 100 according to a first embodiment; and

FIG. 2 is a graph showing an example of a relationship between a frequency of an alternating-current voltage supplied to a power transmitting coil “L1” by a power transmitting unit “TX” shown in FIG. 1 and an electric power “E” transmitted.

### DETAILED DESCRIPTION

A wireless power supply system according to an embodiment includes a power transmitting unit that transmits electric power. The wireless power supply system includes a power receiving unit that receives the electric power output from the power transmitting unit.

The power transmitting unit includes: a power transmitting coil; a first capacitor that is connected in series with the power transmitting coil and forms a first LC resonant circuit in cooperation with the power transmitting coil; a driver that supplies an alternating-current voltage to the power transmitting coil to flow a primary current through the power transmitting coil, thereby driving the power transmitting coil; a message decoder that decodes a received message and outputs information included in the message; and a frequency modulator that controls a frequency of the alternating-current voltage supplied to the power transmitting coil by the driver based on the information output from the message decoder.

The power receiving unit includes: a power receiving coil; a second capacitor that is connected in series with the power receiving coil and forms a second LC resonant circuit in cooperation with the power receiving coil; a rectifier that rectifies a secondary current flowing through the power receiving coil and outputs the rectified secondary current; a counter that counts a frequency of the secondary current; a current detecting circuit that detects an output current output from the rectifier and supplied to a load via an output terminal; a determining circuit that outputs a determination result based on a current detection value, which is the value of the current detected by the current detecting circuit, a count value, which is the value of the frequency counted by the counter, and an output voltage output from the rectifier; and a message transmitter that outputs the message including information on the determination result.

In the following, an embodiment will be described with reference to the drawings.

### First Embodiment

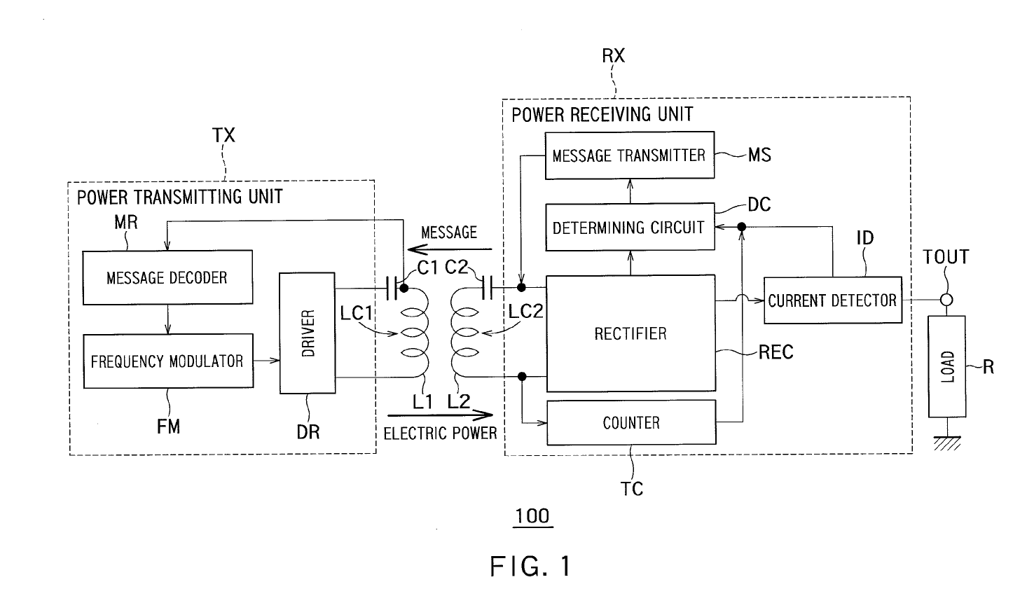

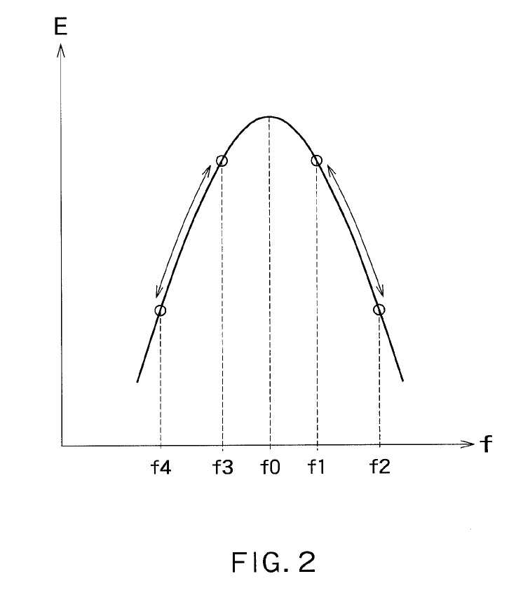

FIG. 1 is a diagram showing an example of a configuration of a wireless power supply system 100 according to a first embodiment. FIG. 2 is a graph showing an example of a relationship between a frequency of an alternating-current voltage supplied to a power transmitting coil “L1” by a power transmitting unit “TX” shown in FIG. 1 and an electric power “E” transmitted.

As shown in FIG. 1, the wireless power supply system 100 includes the power transmitting unit “TX” and a power receiving unit “RX”.

The power transmitting unit “TX” is configured to transmit electric power.

The power receiving unit “RX” is configured to receive the electric power output from the power transmitting unit “TX”.

Power transmission from the power transmitting unit “TX” to the power receiving unit “RX” is achieved by forming a power transmission transformer by electromagnetically coupling a power transmitting coil (primary coil) “L1” provided in the power transmitting unit “TX” and a power receiving coil (secondary coil) “L2” provided in the power receiving unit “RX” with each other. In this way, power transmission can be achieved in a non-contact manner.

As shown in FIG. 1, the power transmitting unit “TX” includes the power transmitting coil “L1”, a first capacitor “C1”, a driver “DR”, a message decoder “MR” and a frequency modulator “FM”, for example. The driver “DR”, the message decoder “MR” and the frequency modulator “FM” form a power transmission controlling apparatus, which is a semiconductor integrated circuit. Note that the power transmission controlling apparatus may include the power transmitting coil “L1” and the first capacitor “C1”.

The power transmitting coil “L1” forms a first LC resonant circuit “LC1”.

The first capacitor “C1” is connected in series with the power transmitting coil “L1” between two outputs of the driver “DR” and forms the first LC resonant circuit “LC1” in cooperation with the power transmitting coil “L1”.

The driver “DR” is configured to supply an alternating-current voltage to the power transmitting coil “L1” to flow a primary current through the power transmitting coil “L1”, thereby driving the power transmitting coil “L1”.

The message decoder “MR” is configured to decode a received message and output information included in the message. For example, the message decoder “MR” receives a message transmitted from a message transmitter “MS” via the power transmitting coil “L1”. Then, the message decoder “MR” decodes the message by envelope detection.

The frequency modulator “FM” is configured to control the frequency of the alternating-current voltage supplied to the power transmitting coil “L1” by the driver “DR” based on the information output from the message decoder “MR”.

The power receiving unit “RX” includes a power receiving coil “L2”, a second capacitor “C2”, a rectifier “REC”, a counter “TC”, a current detecting circuit “ID”, a determining circuit “DC” and a message transmitter “MS”. The rectifier “REC”, the counter “TC”, the current detecting circuit “ID”, the determining circuit “DC” and the message transmitter “MS” form a power reception controlling apparatus, which is a semiconductor integrated circuit. Note that the power reception controlling apparatus may include the power receiving coil “L2” and the second capacitor “C2”.

The power receiving coil “L2” forms a second LC resonant circuit “LC2” and is configured to be electromagnetically coupled with the power transmitting coil “L1”.

The second capacitor “C2” is connected in series with the power receiving coil “L2” between two inputs of the rectifier “REC” and forms the second LC resonant circuit “LC2” in cooperation with the power receiving coil “L2”.

Note that, in order to increase the power transmission efficiency, a resonance frequency of the first LC resonant circuit “LC1” and a resonance frequency of the second LC resonant circuit “LC2” are set to be equal to each other.

The rectifier “REC” is configured to rectify a secondary current flowing through the power receiving coil “L2” and output the rectified secondary current.

The counter “TC” is configured to count a frequency of the secondary current.

The current detecting circuit “ID” is configured to detect the output current (rectified secondary current) output from the rectifier “REC” and supplied to a load “R” via an output terminal “Tout”.

The determining circuit “DC” is configured to output a determination result based on a current detection value, which is the value of the current detected by the current detecting circuit “ID”, a count value, which is the value of the frequency counted by the counter “TC”, and the output voltage output from the rectifier “REC”.

For example, if the output voltage output from the rectifier “REC” deviates from a target voltage, the determining circuit “DC” outputs a determination result that prescribes that the frequency of the alternating-current voltage supplied to the power transmitting coil “L1” by the driver “DR” is changed so as to bring the output voltage close to the target voltage.

Furthermore, if the count value changes even though the current detection value is kept constant (stable), for example, the determining circuit “DC” outputs a determination result that prescribes that the driver “DR” stops driving the power transmitting coil “L1”. More specifically, the determining circuit “DC” outputs a determination result that prescribes that the driver “DR” stops driving the power transmitting coil “L1” if the value of the frequency counted by the counter “TC” changes by an amount equal to or higher than a preset threshold. The message transmitter “MS” is configured to transmit a message including information on the determination result from the determining circuit “DC” to the message decoder “MR” via the power receiving coil “L2” and the power transmitting coil “L1”. For example, the message transmitter “MS” transmits a message in the form of an envelope of a signal propagated by the power transmission transformer formed by the power receiving coil “L2” and the power transmitting coil “L1”.

If the message transmitter “MS” transmits a message including the determination result that prescribes that the driver “DR” stops driving the power transmitting coil “L1” to the message decoder “MR” in the power transmitting unit “TX”, for example, the message decoder “MR” in the power transmitting unit “TX” decodes the message including the determination result that prescribes that the driver “DR” stops driving the power transmitting coil “L1”, and outputs information including the determination result to the frequency modulator “FM”.

Then, the frequency modulator “FM” controls the driver “DR” to stop supplying the alternating-current voltage to the power transmitting coil “L1” based on the information output from the message decoder “MR”. In this way, the driver “DR” stops driving the power transmitting coil “L1”.

Next, an example of an operation of the wireless power supply system 100 which changes the frequency of the alternating-current voltage supplied to the power transmitting coil “L1” by controlling the frequency modulator “FM” shown in FIG. 1 will be described.

First, there will be described an operation of the wireless power supply system 100 in a case where there is no foreign matter that is so close to the wireless power supply system 100 as to have an influence on the electromagnetic coupling and the output voltage (voltage output to the output terminal “Tout” by the rectifier “REC”) varies because of a variation of the load “R”, for example.

As described above, if the output voltage output from the rectifier “REC” deviates from the target voltage, the determining circuit “DC” outputs a determination result that prescribes that the frequency of the alternating-current voltage supplied to the power transmitting coil “L1” by the driver “DR” is changed so as to bring the output voltage close to the target voltage.

For example, if the output voltage output from the rectifier “REC” is lower than the target voltage, the determining circuit “DC” outputs a determination result that prescribes that the frequency of the alternating-current voltage supplied to the power transmitting coil “L1” by the driver “DR” is changed so as to come close to the resonance frequency of the first LC resonant circuit “LC1” (changed from a frequency “f2” to a frequency “fl” or from a frequency “f4” to a frequency “f3” in FIG. 2).

As described above, the resonance frequency of the first LC resonant circuit “LC1” and the resonance frequency of the second LC resonant circuit “LC2” are set to be equal to each other. In other words, if the output voltage output from the rectifier “REC” is lower than the target voltage, the determining circuit “DC” outputs a determination result that prescribes that the frequency of the alternating-current voltage supplied to the power transmitting coil “L1” by the driver “DR” is changed so that the count value comes close to the resonance frequency of the second LC resonant circuit “LC2”.

Then, the message transmitter “MS” transmits a message including information on the determination result from the determining circuit “DC” to the message decoder “MR” via the power receiving coil “L2” and the power transmitting coil “L1”.

Then, the message decoder “MR” decodes the received message and outputs the information included in the message (that is, the information that prescribes that the frequency of the alternating-current voltage supplied to the power transmitting coil “L1” by the driver “DR” is changed so as to come close to the resonance frequency of the first LC resonant circuit “LC1”).

Then, the frequency modulator “FM” controls the frequency of the alternating-current voltage supplied to the power transmitting coil “L1” by the driver “DR” so as to come close to the resonance frequency of the first LC resonant circuit “LC1” based on the information output from the message decoder “MR”.

This causes the transmitted electric power to increase (FIG. 2), and as a result, the output voltage output from the rectifier “REC” increases to come close to the target voltage.

On the other hand, if the output voltage output from the rectifier “REC” is higher than the target voltage, the determining circuit “DC” outputs a determination result that prescribes that the frequency of the alternating-current voltage supplied to the power transmitting coil “L1” by the driver “DR” is changed so as to deviate from the resonance frequency of the first LC resonant circuit “LC1” (changed from the frequency “f1” to the frequency “f2” or from the frequency “f3” to the frequency “f4” in FIG. 2).

As described above, the resonance frequency of the first LC resonant circuit “LC1” and the resonance frequency of the second LC resonant circuit “LC2” are set to be equal to each other. In other words, if the output voltage output from the rectifier “REC” is higher than the target voltage, the determining circuit “DC” outputs a determination result that prescribes that the frequency of the alternating-current voltage supplied to the power transmitting coil “L1” by the driver “DR” is changed so that the count value deviates from the resonance frequency of the second LC resonant circuit.

Then, the message transmitter “MS” transmits a message including information on the determination result from the determining circuit “DC” to the message decoder “MR” via the power receiving coil “L2” and the power transmitting coil “L1”.

Then, the message decoder “MR” decodes the received message and outputs the information included in the message (that is, the information that prescribes that the frequency of the alternating-current voltage supplied to the power transmitting coil “L1” by the driver “DR” is changed so as to deviate from the resonance frequency of the first LC resonant circuit “LC1”).

Then, the frequency modulator “FM” controls the frequency of the alternating-current voltage supplied to the power transmitting coil “L1” by the driver “DR” so as to deviate from the resonance frequency of the first LC resonant circuit “LC1” based on the information output from the message decoder “MR”.

This causes the transmitted electric power to decrease (FIG. 2), and as a result, the output voltage output from the rectifier “REC” decreases to come close to the target voltage.

Next, there will be described an example of the operation of the wireless power supply system 100 in a case where there is a foreign matter that is so close to the wireless power supply system 100 as to have an influence on the electromagnetic coupling.

For example, if there is a foreign matter that is so close to the wireless power supply system 100 as to have an influence on the electromagnetic coupling, the transmitted electric power is partially absorbed by the foreign matter, and the power transmission efficiency decreases. To prevent the output voltage output from the rectifier “REC” from decreasing, the determining circuit “DC” outputs a determination result that prescribes that the count value changes in such a direction as to come close to the resonance frequency of the second LC resonant circuit (from the frequency “f2” to the frequency “f1” or from the frequency “f4” to the frequency “f3” in FIG. 2).

In response to this, the frequency modulator “FM” controls the frequency of the alternating-current voltage supplied to the power transmitting coil “Li” by the driver “DR” so as to come close to the resonance frequency of the first LC resonant circuit “LC1” so that the count value changes in such a direction as to come close to the resonance frequency of the second LC resonant circuit.

As a result, the count value changes in such a direction as to come close to the resonance frequency of the first LC resonant circuit by an amount equivalent to the electric power absorbed by the foreign matter.

Meanwhile, the output voltage output from the rectifier “REC” is controlled to stay at the target voltage. Therefore, the output current output from the rectifier “REC” and supplied to the load “R” via the output terminal “Tout” (the rectified current), that is, the value of the current detected by the current detecting circuit “ID” is substantially kept at a constant value (a converged value that depends on the operation of the load “R”).

Thus, in the case where, even though the current detection value is kept at a stable value, the count value changes in such a direction as to come close to the resonance frequency of the first LC resonant circuit by an amount exceeding a preset predetermined threshold to such an extent that the influence of the variation of the output voltage caused by the load “R” can be excluded, the determining circuit “DC” determines that there is a foreign matter close to the wireless power supply system 100 and outputs a determination result that prescribes that the driver “DR” stops driving the power transmitting coil “L1”.

Thus, if a foreign matter comes close to the wireless power supply system 100, for example, supply of a current to the load “R” can be stopped.

With such a configuration, the wireless power supply system can detect a foreign matter based on the variation of the power transmission frequency and prevent the power transmitting unit from transmitting excessive electric power or transmitting unwanted electric power to the foreign matter, and therefore is improved in safety.

Furthermore, the message transmitter “MS” may output or display, to the outside, information that indicates that a foreign matter is coming close to (or adheres to) the wireless power supply system 100. Furthermore, the message transmitter “MS” may output or display information that indicates actions the user should take in the case where a foreign matter is coming close to (or adheres to) the wireless power supply system 100. The wireless power supply system 100 may further include an output apparatus that outputs or displays such information.

As described above, the wireless power supply system according to the first embodiment can detect a foreign matter based on the power transmission frequency.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless power supply system, comprising:
a power transmitting unit that transmits electric power; and
a power receiving unit that receives the electric power output from the power transmitting unit,
wherein the power transmitting unit comprises:
a power transmitting coil;
a first capacitor that is connected in series with the power transmitting coil and forms a first LC resonant circuit in cooperation with the power transmitting coil;
a driver that supplies an alternating-current voltage to the power transmitting coil to flow a primary current through the power transmitting coil, thereby driving the power transmitting coil;
a message decoder that decodes a received message and outputs information included in the message; and
a frequency modulator that controls a frequency of the alternating-current voltage supplied to the power transmitting coil by the driver based on the information output from the message decoder, and
the power receiving unit comprises:
a power receiving coil;
a second capacitor that is connected in series with the power receiving coil and forms a second LC resonant circuit in cooperation with the power receiving coil;
a rectifier that rectifies a secondary current flowing through the power receiving coil and outputs the rectified secondary current;
a counter that counts a frequency of the secondary current;
a current detecting circuit that detects an output current output from the rectifier and supplied to a load via an output terminal;
a determining circuit that outputs a determination result based on a current detection value, which is the value of the current detected by the current detecting circuit, a count value, which is the value of the frequency counted by the counter, and an output voltage output from the rectifier; and
a message transmitter that outputs a message including information on the determination result.

2. The wireless power supply system according to claim 1, wherein the determining circuit
outputs a determination result that prescribes that the driver stops driving the power transmitting coil if the count value changes beyond a predetermined threshold even though the current detection value is kept at a stable value.

3. The wireless power supply system according to claim 2, wherein the determining circuit
outputs the determination result that prescribes that the driver stops driving the power transmitting coil if the count value changes beyond a predetermined threshold in such a direction as to come close to a resonance frequency of the second LC resonant circuit even though the current detection value is kept at a stable value.

4. The wireless power supply system according to claim 1, wherein the message transmitter outputs or displays information that indicates that a foreign matter is coming close to the wireless power supply system.

5. The wireless power supply system according to claim 2, wherein the message transmitter outputs or displays information that indicates that a foreign matter is coming close to the wireless power supply system.

6. The wireless power supply system according to claim 1, wherein the frequency modulator controls the frequency of the alternating-current voltage supplied to the power transmitting coil by the driver so as to come close to a resonance frequency of the second LC resonant circuit in the case where a foreign matter is coming close to the wireless power supply system.

7. The wireless power supply system according to claim 2, wherein the frequency modulator controls the frequency of the alternating-current voltage supplied to the power transmitting coil by the driver so as to come close to a resonance frequency of the second LC resonant circuit in the case where a foreign matter is coming close to the wireless power supply system.

8. A power reception controlling apparatus used in a power receiving unit comprising a power receiving coil that receives electric power transmitted from a power transmitting coil to achieve wireless power supply and a capacitor that is connected in series with the power receiving coil and forms an LC resonant circuit in cooperation with the power receiving coil, the power reception controlling apparatus comprising:
a rectifier that rectifies a secondary current flowing through the power receiving coil and outputs the rectified secondary current;
a counter that counts a frequency of the secondary current;
a current detecting circuit that detects the output current output from the rectifier and supplied to a load via an output terminal;
a determining circuit that outputs a determination result based on a current detection value, which is the value of the current detected by the current detecting circuit, a count value, which is the value of the frequency counted by the counter, and an output voltage output from the rectifier; and
a message transmitter that outputs the message including information on the determination result.

9. The power reception controlling apparatus according to claim 8, further comprising:
the power transmitting coil; and
the capacitor.

10. The power reception controlling apparatus according to claim 8, wherein the determining circuit outputs a determination result that prescribes that the power transmitting coil stops transmitting electric power if the count value changes beyond a predetermined threshold even though the current detection value is kept at a stable value.

11. The power reception controlling apparatus according to claim 9, wherein the determining circuit outputs a determination result that prescribes that the power transmitting coil stops transmitting electric power if the count value changes beyond a predetermined threshold even though the current detection value is kept at a stable value.

12. The power reception controlling apparatus according to claim 8, wherein the message transmitter outputs or displays, to an outside, information that indicates that a foreign matter is coming close to the power reception.

13. The power reception controlling apparatus according to claim 9, wherein the message transmitter outputs or displays, to an outside, information that indicates that a foreign matter is coming close to the power reception.

14. The power reception controlling apparatus according to claim 8, wherein the message included a frequency of the alternating-current voltage supplied to the power transmitting coil so as to come close to a resonance frequency of the LC resonant circuit in the case where a foreign matter is coming close to the power reception.

15. The power reception controlling apparatus m according to claim 10, wherein the message included a frequency of the alternating-current voltage supplied to the power transmitting coil so as to come close to a resonance frequency of the LC resonant circuit in the case where a foreign matter is coming close to the power reception.

16. A power transmission controlling apparatus used in a power transmitting unit comprising a power transmitting coil that transmits electric power to a power receiving unit, the power receiving unit having: a power receiving coil; a second capacitor that is connected in series with the power receiving coil and forms a second LC resonant circuit in cooperation with the power receiving coil; a rectifier that rectifies a secondary current flowing through the power receiving coil and outputs the rectified secondary current; a counter that counts a frequency of the secondary current; a current detecting circuit that detects an output current output from the rectifier and supplied to a load via an output terminal; a determining circuit that outputs a determination result based on a current detection value, which is the value of the current detected by the current detecting circuit, a count value, which is the value of the frequency counted by the counter, and an output voltage output from the rectifier; and a message transmitter that transmits a message including information on the determination result from the determining circuit to the message decoder, the power transmission controlling apparatus comprising:
a driver that supplies an alternating-current voltage to the power transmitting coil to flow a primary current through the power transmitting coil, thereby driving the power transmitting coil;
a message decoder that decodes a received message and outputs information included in the message; and
a frequency modulator that controls a frequency of the alternating-current voltage supplied to the power transmitting coil by the driver based on the information output from the message decoder,
wherein, based on the information, the frequency modulator makes the driver stop driving the power transmitting coil if the count value changes beyond a predetermined threshold even though the current detection value is kept at a stable value.

17. The power transmission controlling apparatus according to claim 16, further comprising:
a power transmitting coil; and
a first capacitor that is connected in series with the power transmitting coil and forms a first LC resonant circuit in cooperation with the power transmitting coil.

18. The power transmission controlling apparatus according to claim 16, wherein the message transmitter outputs or displays information that indicates that a foreign matter is coming close to the power transmission.

19. The power transmission controlling apparatus according to claim 16, wherein the frequency modulator controls the frequency of the alternating-current voltage supplied to the power transmitting coil by the driver so as to come close to a resonance frequency of the second LC resonant circuit in the case where a foreign matter is coming close to the wireless power supply system.

20. The power transmission controlling apparatus according to claim 17, wherein the frequency modulator controls the frequency of the alternating-current voltage supplied to the power transmitting coil by the driver so as to come close to a resonance frequency of the first LC resonant circuit in the case where a foreign matter is coming close to the wireless power supply system.
